(19) United States
(12) Patent Application Publication
(10) Pub. No.: US 2025/0183806 A1
(43) Pub. Date: Jun. 5, 2025

(54) POWER SUPPLY APPARATUS AND IMAGE FORMING APPARATUS USING POWER SUPPLY APPARATUS

(71) Applicant: CANON KABUSHIKI KAISHA, Tokyo (JP)

(72) Inventor: HIROKI HANAYAMA, Kanagawa (JP)

(21) Appl. No.: 18/966,277

(22) Filed: Dec. 3, 2024

(30) Foreign Application Priority Data
Dec. 5, 2023 (JP) 2023-205436

(51) Int. Cl. H02M 3/335; G03G 15/00; H02M 1/00; H02M 1/32

(52) U.S. Cl. CPC H02M 3/33523; G03G 15/5004; G03G 15/80; H02M 1/0009; H02M 1/32; H02M 3/33515

(57) ABSTRACT

A power supply circuit generates an output voltage. A current detection circuit detects a current flowing through a load. An AD converter reads an output signal from the current detection circuit. A determination circuit determines whether an overvoltage may be applied to an input terminal of the AD converter. A protection circuit protects the input terminal of the AD converter from the overvoltage. Upon determining that the overvoltage may be applied to the input terminal, a controller controls the protection circuit to reduce a voltage applied to the input terminal of the AD converter.

### BACKGROUND OF THE INVENTION

### Field of the Invention

The present invention relates to a power supply apparatus and an image forming apparatus using the power supply apparatus.

### Description of the Related Art

An electrophotographic image forming apparatus utilizes a variety of high voltages. Therefore, a power supply apparatus capable of outputting a high voltage is required. According to Japanese Patent Laid-Open No. 2015-043674, a power supply apparatus having a circuit for detecting a current flowing from a positive high voltage power supply and a circuit for detecting a current flowing from a negative high voltage power supply has been proposed.

Incidentally, in order to accurately control the output of the power supply apparatus, it is required to detect a current with a high resolution. For example, in order to improve the resolution while maintaining a detection range of the current detection circuit, it is required to increase a detection resistor of the current detection circuit and increase a reference voltage of the current detection circuit. However, if the reference voltage of the current detection circuit is higher than a power supply voltage for a central processing unit (CPU), then this can be problematic. That is, when the power supply apparatus is not outputting a high voltage, a voltage equal to or higher than the power supply voltage for the CPU is applied to the CPU. Consequently, the CPU may be damaged or destroyed.

### SUMMARY OF THE INVENTION

The present disclosure provides a power supplying apparatus comprising: a power supply circuit configured to generate an output voltage; a current detection circuit configured to detect a current flowing through a load to which the output voltage is applied; and a controller configured to control the power supply circuit based on an output signal output from the current detection circuit. The controller comprises an AD converter configured to read the output signal, a determination circuit configured to determine whether an overvoltage may be applied to an input terminal of the AD converter; and a protection circuit configured to protect the input terminal of the AD converter from the overvoltage. In a case where the determination circuit determines that the overvoltage may be applied to the input terminal of the AD converter, the controller controls the protection circuit to reduce a voltage applied to the input terminal of the AD converter.

Further features of the present invention will become apparent from the following description of exemplary embodiments (with reference to the attached drawings).

### BRIEF DESCRIPTION OF THE DRAWINGS

FIG. 1 is a schematic cross-sectional view illustrating an image forming apparatus.

FIG. 2 is a circuit diagram of power supply apparatus.

FIG. 3 is a flowchart showing a control method.

FIG. 4 is a diagram showing each voltage.

FIG. 5 is a circuit diagram of power supply apparatus.

FIG. 6 is a diagram showing each voltage.

FIG. 7 is a circuit diagram of power supply apparatus.

FIG. 8 is a circuit diagram of power supply apparatus.

FIG. 9 is a flowchart showing a control method.

FIG. 10 is a flowchart showing a control method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### Example 1

### 1. Image Forming Apparatus

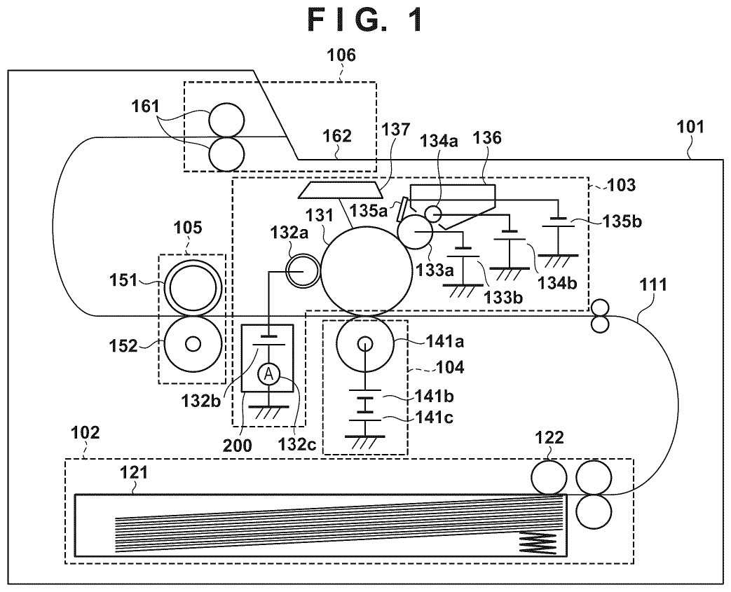

As illustrated in FIG. 1, an image forming apparatus 101 includes a feeding unit 102, a conveyance path 111, an image forming unit 103, a transfer unit 104, a fixing unit 105, and a discharge unit 106. The feeding unit 102 includes a feeding tray 121 and a feeding roller 122. The feeding tray 121 can accommodate a large number of sheets S to be printed. The feeding roller 122 feeds the sheet S stored in the feeding tray 121 to the conveyance path 111. The sheet S is conveyed along the conveyance path 111 and is conveyed to the transfer unit 104.

The image forming unit 103 includes a photosensitive drum 131, a charging roller 132a, a developing roller 133a, a toner supplying roller 134a, a developing blade 135a, a toner container 136, a laser scanner 137, and the like. A charging circuit 132b of a power supply apparatus 200 is a power supply circuit that generates a high voltage (charging voltage) and applies the high voltage (charging voltage) to the charging roller 132a. A current detection circuit 132c is connected in series between the charging circuit 132b and a frame ground (GND), and detects a current flowing through the charging roller 132a as a load. The charging roller 132a charges a surface of the photosensitive drum 131. The photosensitive drum 131 is an electrostatic latent image or an image carrier that carries toner images and rotates. The laser scanner 137 irradiates the surface of the photosensitive drum 131 with a laser beam according to image data to form an electrostatic latent image corresponding to the image data. The laser scanner 137 may be referred to as an exposure apparatus or an optical scanning apparatus. Instead of the laser scanner 137, a solid-state exposure apparatus using a plurality of light-emitting diodes may be employed.

A developing circuit 133b is a power supply circuit that generates a high voltage (development bias) and applies it to the developing roller 133a. A toner supplying roller circuit 134b is a power supply circuit that generates a high voltage and applies it to the toner supplying roller 134a. A blade circuit 135b generates and applies a high voltage to the developing blade 135a. As a result, the toner stored in the toner container 136 is applied to the developing roller 133a by the toner supplying roller 134a, and the toner applied to the developing roller 133a is leveled by the developing blade 135a. The developing roller 133a develops electrostatic latent image by adhering the toner to the surface of the photosensitive drum 131 to form toner images. As the photosensitive drum 131 rotates, the toner image is conveyed to the transfer unit 104.

The transfer unit 104 includes a transfer roller 141a, a transfer positive circuit 141b, and a transfer negative circuit 141c. The transfer positive circuit 141b is a power supply circuit that applies a positive high voltage to the transfer roller 141a and promotes transfer of toner images from the photosensitive drum 131 to a sheet S. The transfer negative circuit 141c is an optional power supply circuit that applies a negative high voltage to the transfer roller 141a. The transfer negative circuit 141c retransfers the toner adhering to the transfer roller 141a to the photosensitive drum 131 and cleans the transfer roller 141a. The transfer positive circuit 141b and the transfer negative circuit 141c are connected in series between the transfer roller 141a and the GND. The transfer negative circuit 141c and the transfer positive circuit 141b may be connected in parallel. In this case, a switch for selecting a high voltage power supply connected to the transfer roller 141a among the transfer negative circuit 141c and the transfer positive circuit 141b may be employed. Note that the transfer negative circuit 141c may be omitted. The transfer roller 141a is disposed so as to oppose the photosensitive drum 131 and contact the photosensitive drum 131. The fixing unit 105 includes a fixing roller 151 and a pressure roller 152. The fixing roller 151 has a heater and heats the toner image and the sheet S. The pressure roller 152 presses the toner image and the sheet S passing through the fixing nip formed by the fixing roller 151 and the pressure roller 152. As a result, the toner image is fixed on the sheet S.

The discharge unit 106 includes a discharge roller 161 and a discharge tray 162. The discharge roller 161 discharges the sheet S conveyed from the fixing unit 105 to the discharge tray 162.

### 2. Image Forming Process

Here, it is assumed that the toner is negatively charged. If the toner is positively charged, the polarity described below is reversed.

### 2-1. Charging Process

The charging circuit 132b applies a negative high voltage to the charging roller 132a, and the charging roller 132a charges the surface of the photosensitive drum 131. Here, a roller charging scheme is adopted, but a wire charging scheme or the like may be used. The charging roller 132a and the photosensitive drum 131 face each other with a slight gap therebetween. The electrical discharge generated in the gap charges the surface of the photosensitive drum 131.

### 2-2. Exposure Process

The laser scanner 137 irradiates the photosensitive drum 131 with a laser beam according to the image data, and forms an electrostatic latent image on the surface of the photosensitive drum 131.

### 2-3. Development Process

The toner stored in the toner container 136 is stirred to be negatively charged. The toner supplying roller circuit 134b applies a negative high voltage to the toner supplying roller 134a. As a result, the toner moves to the surface of the developing roller 133a and adheres to the surface. The height of the toner group adhering to the surface of the developing roller 133a may be uneven. The blade circuit 135b applies a negative high voltage to the developing blade 135a, and the developing blade 135a levels the toner group. The developing roller 133a moves the toner to the surface of the photosensitive drum 131 by using the negative high voltage applied from the developing circuit 133b. As a result, the electrostatic latent image is developed to form a toner image. Here, an absolute value of an output voltage of the toner supplying roller circuit 134b is larger than an absolute value of an output voltage of the developing circuit 133b. This makes it easier for the negatively charged toner to move toward the developing roller 133a. An absolute value of an output voltage of the blade circuit 135b is larger than an absolute value of an output voltage of the developing circuit 133b. This makes it difficult for the negatively charged toner to adhere to the developing blade 135a. For example, the output voltage of the developing circuit 133b is −300V. Each of the output voltage of the toner supplying roller circuit 134b and the output voltage of the blade circuit 135b is −400V.

### 2-4. Transfer Process

When the Photosensitive Drum 131 and the Transfer Roller 141a Come into contact with each other, a transfer nip is formed. When the sheet S passes through the transfer nip, the toner image is transferred from the photosensitive drum 131 to the sheet S. The transfer positive circuit 141b applies a positive high voltage to the transfer roller 141a.

### 2-5. Fixing Process

When the sheet S passes through the fixing nip of the fixing unit 105, heat and pressure are applied to the sheet S and the toner image. As a result, the toner image is fixed on the sheet S.

Here, a monochrome image forming apparatus 101 is shown, but this is only an illustration. The technical idea of the embodiment can also be applied to a full-color image forming apparatus. The image forming apparatus 101 may be a printer, a copying machine, a multifunction peripheral, or a facsimile machine.

### 3. Power Supply Apparatus

As shown in FIG. 1, the image forming apparatus 101 includes various power supply circuits such as the charging circuit 132b, the developing circuit 133b, the toner supplying roller circuit 134b, the blade circuit 135b, the transfer positive circuit 141b, and the transfer negative circuit 141c. Hereinafter, the charging circuit 132b will be described as a representation thereof. Note that the explanation regarding the charging circuit 132b is also applicable to these other power supply circuits.

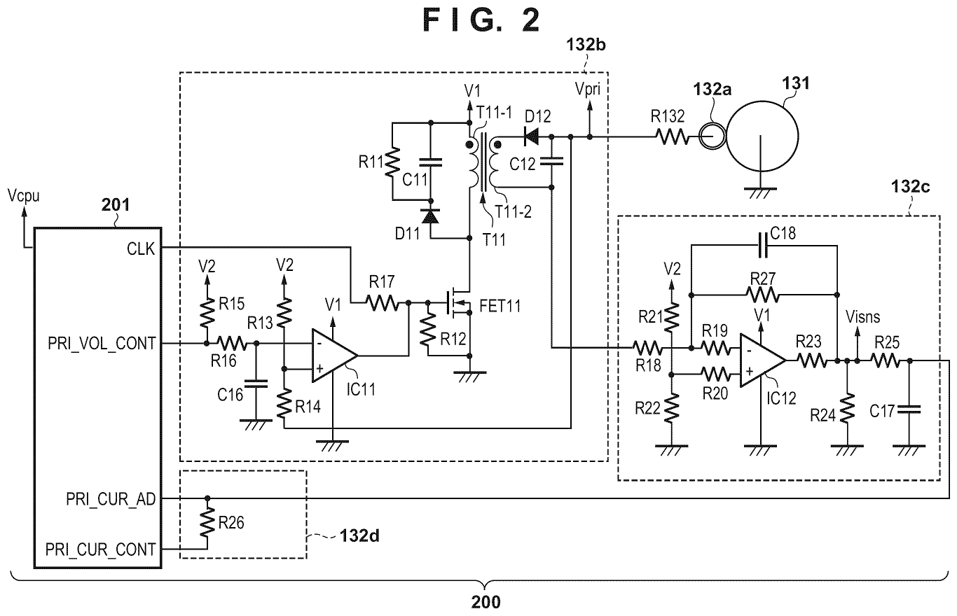

FIG. 2 shows a power supply apparatus 200 including a charging circuit 132b and its peripheral circuits. The control unit 201 is, for example, a central processing unit (CPU) or an application-specific integrated circuit (ASIC), or a combined control circuit thereof. For example, the control unit 201 includes a CPU, a plurality of signal-transmitting circuits (e.g., a digital-to-analog converter (DAC)), a plurality of analog-to-digital converters (ADC), and a timer circuit. The control unit 201 is connected to the charging circuit 132b, the current detection circuit 132c, and a protection circuit 132d. The control unit 201 has various input terminals and output terminals. A CLK terminal outputs a clock signal to the charging circuit 132b. A PRI_VOL_CONT terminal is an output terminal for outputting a control signal to the charging circuit 132b. A PRI_CUR_AD terminal is an input terminal with an ADC for converting a detection result of the current detection circuit 132c from an analog value to a digital value. A PRI_CUR_CONT terminal is an output terminal for outputting a control signal to the protection circuit 132d. The protection circuit 132d is a circuit for protecting the PRI_CUR_AD terminal from overvoltage.

### 3-1. Charging Circuit

### 3-1-1. Switching Circuit

The charging circuit 132b is a flyback-type switching power supply circuit. As shown in FIG. 2, a transformer T11 has a primary winding T11-1 and a secondary winding T11-2. A power supply voltage V1 is applied to one terminal of the primary winding T11-1. The power supply voltage V1 is, for example, a 24V. A drain terminal of a FET11 is connected to the other terminal of the primary winding T11-1. The FET11 is a field-effect transistor that functions as a switching device. One end of a resistor R12, one end of a resistor R17, and an output terminal of a comparator IC11 are connected to a gate terminal of the FET11. The other end of the resistor R12 is connected to the GND.

The other end of the resistor R17 is connected to the CLK terminal of the control unit 201. A parallel circuit composed of a capacitor C11 and a resistor R11 and a diode D11 connected in series to the parallel circuit are connected between one terminal and the other terminal of the primary winding T11-1.

A rectifying/smoothing circuit including a diode D12 and a capacitor C12 is connected between one terminal and the other terminal of the secondary winding T11-2. More specifically, a cathode of the diode D12 is connected to the one terminal of the secondary winding T11-2 of the transformer T11. An anode of the diode D12 is connected to one terminal of the capacitor C12. The other terminal of the capacitor C12 is connected to the other terminal of the secondary winding T11-2 and the current detection circuit 132c.

When a high (Hi) state signal is outputted from the CLK terminal of the control unit 201, the FET11 is turned on, and a potential of a drain terminal of the FET11 decreases to a potential of the GND approximately. As a result, a voltage is applied to both ends of the primary winding T11-1, and an exciting current flows through the primary winding T11-1. When the voltage outputted from the CLK terminal changes to a low (Lo) state, the FET11 is turned off, and a flyback voltage is generated at both ends of the primary winding T11-1. At the same time, the secondary winding T11-2 generates a flyback voltage corresponding to a turn ratio between the primary winding T11-1 and the secondary winding T11-2. As a result, a secondary side current due to the flyback voltage is rectified and smoothed by the diode D12 and the capacitor C12. As a result, a charging voltage Vpri is generated.

A waveform of the voltage outputted from the CLK terminal of the control unit 201 is a rectangular wave in which the Hi state and the Lo state are alternately appeared. In the Example 1, a frequency of the rectangular wave outputted from the CLK terminal is, for example, 50 kHz. The duty ratio is, for example, 10%. The frequency and duty ratio of the rectangular wave should be designed according to the specifications required for each power supply circuit. The frequency and the duty ratio of the rectangular wave may not be fixed values. The frequency and the duty ratio of the rectangular wave may be changed depending on the voltage and the load to be controlled.

As described above, the FET11 repeatedly turns on/off (switches), and thus the flyback voltage is generated in the secondary winding T11-2. The secondary side current based on the flyback voltage is rectified and smoothed by the diode D12 and the capacitor C12. As a result, a direct-current charging voltage Vpri is generated between both ends of the capacitor C12.

### 3-1-2. Feedback Circuit

The charging circuit 132b performs feedback-control to stably control the charging voltage Vpri to a desired value. The charging voltage Vpri is a very high voltage. Therefore, a voltage divider (voltage dividing circuit) including the resistor R14 and the resistor R13 divides the charging voltage Vpri and generates a detection voltage proportional to the charging voltage Vpri. One end of the resistor R14 is connected to the anode of the diode D12. The other end of the resistor R13 is connected to the positive input terminal (non-inverting input terminal) of the comparator IC11 and one end of the resistor R14. The other end of the resistor R13 is connected to a power supply voltage V2. The power supply voltage V2 is, for example, 5V. As described above, a connection point between the resistor R14 and the resistor R13 is connected to the positive input terminal of the comparator IC11. The negative input terminal (inverting input terminal) of the comparator IC11 is connected to the power supply voltage V2 via a resistor R16 and a resistor R15. Further, the negative input terminal of the comparator IC11 is connected to the GND via the capacitor C16. The connection point between the resistor R15 and the resistor R16 is connected to the PRI_VOL_CONT terminal of the control unit 201.

The output terminal of the comparator IC11 is connected to the gate terminal of the FET11. The PRI_VOL_CONT terminal outputs a pulse signal that alternately repeats ta high-impedance (hereinafter referred to as Hi-Z) state and a Lo state. When the PRI_VOL_CONT terminal is Hi-Z, a current flows from the power supply voltage V2 to the capacitor C16 via the resistor R15 and the resistor R16. Thus, the capacitor C16 is charged. On the other hand, when the PRI_VOL_CONT terminal is the Lo state, a current flows from the capacitor C16 toward the PRI_VOL_CONT terminal via the resistor R16 so that the capacitor C16 is discharged. When the PRI_VOL_CONT terminal repeats the Hi-Z state and the Lo state, charging and discharging of the capacitor C16 are balanced, and the voltage between the two terminals of the capacitor C16 is stabilized at a predetermined voltage. Therefore, the voltage of the negative input terminal of the comparator IC11 is determined according to the duty ratio of the pulse signal outputted from the PRI_VOL_CONT terminal. The control unit 201 can control the charging voltage Vpri by adjusting the duty ratio of the pulse signal outputted from the PRI_VOL_CONT terminal.

During a period in which the charging voltage Vpri is outputted, a detection voltage (feedback voltage) proportional to the charging voltage Vpri is applied to the comparator IC11. When the voltage at the negative input terminal of the comparator IC11 is lower than the voltage at the positive input terminal (the detection voltage), the output terminal of the comparator IC11 becomes Hi-Z. The signal outputted from the CLK terminal of the control unit 201 directly turns on/off the FET11. On the other hand, when the voltage at the negative input terminal of the comparator IC11 is higher than the voltage at the positive input terminal, the output terminal of the comparator IC11 becomes Lo. The current output from the CLK terminal is induced to the GND by the output terminal of the comparator IC11. Therefore, the voltage of the gate terminal of the FET11 is forcibly Lo. Since the FET11 cannot be turned on at the timing to be turned on, the absolute value of the charging voltage Vpri is promoted to decrease. By this operation, the charging voltage Vpri is feedback-controlled to a desired target voltage.

As described above, since the feedback circuit is provided around the comparator IC11, a stable charging voltage Vpri is generated and applied to the charging roller 132a. The resistor R132 may optionally be inserted between the charging circuit 132b and the charging roller 132a to limit the output current. In the Example 1, the charging voltage Vpri is, for example, −1000V.

### 3-2. Current Detection Circuit

As illustrated in FIG. 2, the current detection circuit 132c is a circuit that detects a current supplied from the charging circuit 132b to the charging roller 132a (hereinafter, referred to as a charging current Ipri). The control unit 201 may control the charging voltage Vpri so that the charging current Ipri becomes a target value. In other words, the control unit 201 adjusts the duty ratio of the pulse signal outputted from the PRI_VOL_CONT terminal so that the difference between the charging current Ipri and the target value is reduced. The protection circuit 132d is a circuit that makes it difficult to apply an overvoltage to the PRI_CUR_AD terminal of the control unit 201.

The connection point between the secondary winding T11-2 and the capacitor C12 is connected to the negative input terminal of an operational amplifier IC12 via a resistor R18 and a resistor R19. A positive input terminal of the operational amplifier IC12 is connected to the power supply voltage V2 via a resistor R20 and a resistor R21. The connection point between the resistor R20 and the resistor R21 is connected to the GND via a resistor R22. An output terminal of the operational amplifier IC12 is connected to the GND via a resistor R23 and a resistor R24. The connection point between the resistor R23 and the resistor R24 is connected to the PRI_CUR_AD terminal of the control unit 201 via a resistor R25. A resistor R26 is connected between the PRI_CUR_AD terminal and the PRI_CUR_CONT terminal of the control unit 201. The PRI_CUR_AD terminal is connected to the GND via a capacitor C17. A connection point between the resistor R18 and the resistor R19 is connected to a connection point between the resistor R23, the resistor R24, and the resistor R25 via a parallel circuit including a resistor R27 and a capacitor C18. The capacitor C18 is provided to reduce oscillation. The voltage at the connection point of the resistor R23, the resistor R24, the resistor R25, and the resistor R27 is described as Visns.

The charging current Ipri generated in the secondary winding T11-2 flows to the GND through the resistor R18, the resistor R27, and the resistor R24. Further, the charging current Ipri flows back from another GND to the secondary winding T11-2 through a metallic casing or the like via the photosensitive drum 131, the charging roller 132a, the resistor R132, and the diode D12. A voltage generated by dividing the power supply voltage V2 by the resistor R21 and the resistor R22 is applied to a positive input terminal of the operational amplifier IC12 as an operating reference voltage of the operational amplifier IC12. The positive input terminal and the negative input terminal of the operational amplifier IC12 have the same potential due to virtual grounding. Therefore, under a condition that the virtual grounding of the operational amplifier IC12 is maintained, the Visns is controlled from the operating reference voltage of the operational amplifier IC12 to the voltage lowered by the resistor R27 in accordance with the magnitude of the charging current Ipri. That is, depending on the resistance value of the resistor R27, the lowering amount that changes in accordance with the quantity of the charging current Ipri changes. Specifically, as the resistance of the resistor R27 increases, a small change in the charging current Ipri can be detected (resolution improvement). When the charging current Ipri does not flow, the Visns has the same potential as the operating reference voltage of the operational amplifier IC12. When the PRI_CUR_CONT terminal is controlled to Hi-Z, the Visns is applied to the PRI_CUR_AD terminal (detection state). On the other hand, when PRI_CUR_CONT terminal is controlled to be Lo, a voltage generated by dividing Visns by the resistor R25 and the resistor R26 is applied to the PRI_CUR_AD terminal (protection state).

In this way, when the charging current Ipri is detected, the control unit 201 controls the PRI_CUR_CONT terminal to Hi-Z to detect the voltage inputted to the PRI_CUR_AD terminal. When the charging current Ipri is not detected, the control unit 201 controls the PRI_CUR_CONT terminal to Lo, thereby suppressing the operating reference voltage of the operational amplifier IC12 from being applied to the PRI_CUR_AD terminal. The operational reference voltage of the operational amplifier IC12 is, for example, 5V. This is higher than the operating reference voltage (Vcpu=3V) of the control unit 201.

### 4. Control Method of the Example 1

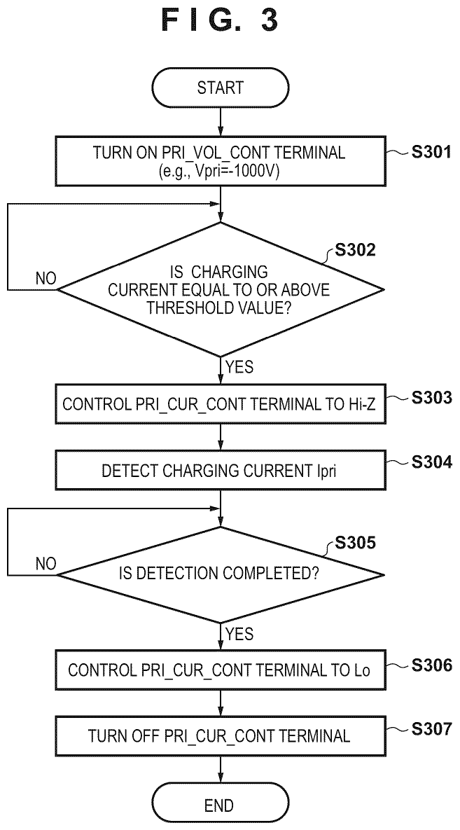

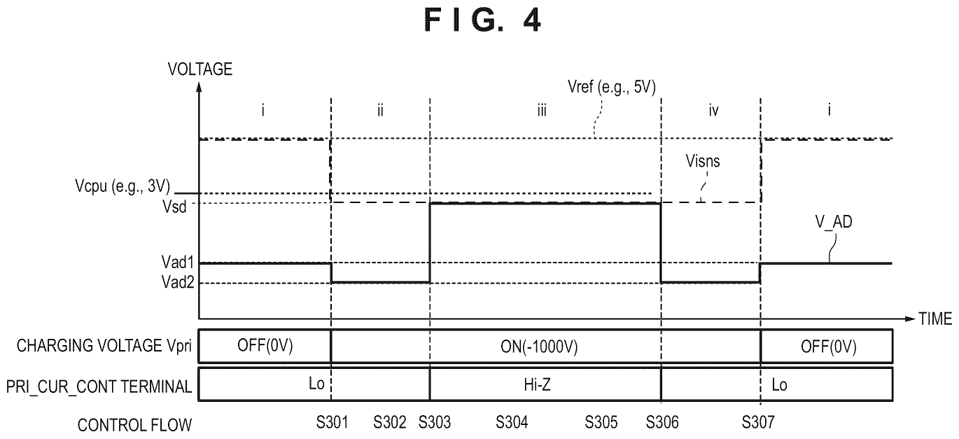

As shown in FIG. 2, a signal line of the PRI_CUR_AD terminal is connected to the PRI_CUR_CONT terminal via the resistor R26. Hereinafter, a method of detecting the charging current Ipri and a method of protecting PRI_CUR_AD terminal executed by the control unit 201 will be described. FIG. 3 is a flowchart illustrating a control method executed by the control unit 201. FIG. 4 is a diagram illustrating a signal and a voltage according to the Example 1. A horizontal axis indicates time. A vertical axis basically represents the voltage.

In FIG. 4, a control flow has four phases i to iv. The phase i is the preparation phase prior to outputting the charging voltage Vpri and during which the PRI_CUR_AD terminal is protected. The phase ii is a phase in which the charging voltage Vpri is started to be outputted and the PRI_CUR_AD terminal is protected. The phase iii is a phase in which the charging voltage Vpri is outputted and the PRI_CUR_AD terminal detects the charging current Ipri. The phase iv is a phase in which the charging voltage Vpri is outputted and the PRI_CUR_AD terminal is protected.

The phase ii includes steps (hereinafter abbreviated as S) 301, S302 and S303 shown in FIG. 3. The phase iii includes S304, S305 and S306. The phase iv includes S307.

In the phase i, the control unit 201 sets an initial state of the PRI_CUR_CONT terminal to Lo. The Visns prior to executing a process of detecting the charging current Ipri (hereinafter referred to as the sensing process) is at the same potential as the operating reference voltage Vref of the operational amplifier IC12. The voltage V_AD applied to the PRI_CUR_AD terminal is a voltage Vad1 generated by dividing the voltage Visns (=Vref) by the resistor R25 and the resistor R26.

In the phase ii, a process of raising the charging voltage Vpri to a target voltage is started. The control unit 201 executes processing according to the flowchart shown in FIG. 3.

In S301, the control unit 201 outputs a control signal from the the PRI_VOL_CONT terminal such that the charging voltage Vpri becomes the target voltage (e.g., 1000V). That is, the control unit 201 starts (ON) outputting from the PRI_VOL_CONT terminal. As shown in FIG. 4, the Visns is controlled from an operating reference voltage Vref (=5V) of the operational amplifier IC12 to a voltage Vsd that is lowered in accordance with the charging current Ipri. The voltage V_AD is a voltage Vad2 generated by dividing the voltage Visns (=Vsd) by the resistor R25 and the resistor R26.

In S302, the control unit 201 determines whether or not the charging current Ipri is equal to or greater than a threshold value Ith. The threshold value Ith is a threshold value for determining that the voltage V_AD applied to the PRI_CUR_AD terminal is within a range that does not cause a defect of the control unit 201. The range in which the control unit 201 does not cause a defect refers to a range that is equal to or lower than the power supply voltage (power supply voltage Vcpu=3V for CPU) of the control unit 201 and equal to or higher than 0. In the phase ii, the Visns is generated by lowering the operating reference voltage Vref of the operational amplifier IC12 by the resistor R27. The range of the charging current Ipri is uniquely determined according to the lowering amount (R27×Ipri) required for the Visns to satisfy the above range and the resistance of the resistor R27.

$$Visns = Vref - R 27 \times Ipri = < 3 V \qquad Eq . 1$$

$$Ipri >= ( Vref - 3 V ) / R 27 \qquad Eq . 2$$

There is a case where the charging voltage Vpri is a negative voltage, and the absolute value of the charging voltage Vpri is need to be larger |−600V| (e.g., Vpri=−1000V). Also in this case, the Visns can satisfy the above-described range. For this reason, −600V is adopted as the threshold value for the charging voltage Vpri. That is, the threshold value Ith compared with the charging current Ipri is a value corresponding to −600V.

A threshold value may be provided for a voltage applied to the PRI_CUR_AD terminals in a protection state described below. That is, there is no restriction on the setting of the threshold value, and the threshold value is sufficient if it can be determined that the charging current Ipri satisfies the scope of the expression Eq.2.

The control unit 201 proceeds from S302 to S303 when it is determined in S302 that the charging current Ipri is equal to or larger than the threshold value Ith. In S303, the control unit 201 controls the PRI_CUR_CONT terminal from Lo to Hi-Z. This causes the phase to transition from ii to iii. In the phase iii, the voltage Visns and the voltage V_AD of the PRI_CUR_AD terminal are equal to each other.

In S304, the control unit 201 detects an output of the current detection circuit 132c, that is, the charging current Ipri, based on the voltage V_AD input to the PRI_CUR_AD terminal (detection process).

In S305, the control unit 201 determines whether the detection of the charging current Ipri is completed. For example, when the analog-to-digital conversion of the voltage V_AD inputted to the PRI_CUR_AD terminal is completed and the digital value of the voltage V_AD is obtained, the control unit 201 determines that the detection of the charging current Ipri is completed. The control unit 201 waits for the detection to be completed, and proceeds from S305 to S306.

In S306, the control unit 201 controls the PRI_CUR_CONT terminal to be Lo. This causes the phase to transition from iii to iv. The voltage V_AD of the PRI_CUR_AD terminal is controlled to the voltage Vad2 generated by dividing the voltage Visns (=Vsd) by the resistor R25 and the resistor R26.

In S307, the control unit 201 stops outputting a control signal from the PRI_VOL_CONT terminal. This corresponds to the PRI_VOL_CONT terminal being controlled to OFF in FIG. 4. Since the Visns returns to the Vref, the voltage V_AD returns to the Vad1.

According to the Example 1, by increasing the resistance of the resistor R27, the charging current Ipri can be detected with a high resolution during a period (phase iii) in which the charging voltage Vpri having a high voltage is outputted. In addition, during a period (phase i, ii, iv) in which the charging voltage Vpri is not outputted, the overvoltage is suppressed from being applied to the PRI_CUR_AD terminal of the control unit 201 by dividing the Visns by the resistor R25 and the resistor R36. That is, with a relatively inexpensive circuit configuration, it is possible to reduce the overvoltage to the control unit at the time of high voltage non-output. Further, by increasing the resistance of the resistor R27, a current can be detected with a high resolution at the time of outputting a high voltage.

### Example 2

In the Example 1, the resistor R25 is connected between the output part of the Visns and the PRI_CUR_AD terminal. In order to improve the responsiveness of the PRI_CUR_AD terminal without lowering the capacitance of the capacitor C17 (i.e., while maintaining disturbance resistance), it is effective to reduce the resistor R25. However, in order to reduce the resistor R25 in the Example 1, the current that PRI_CUR_CONT terminal must draw in increases. Therefore, the control unit 201 is required to have a high driving capability. Therefore, in the Example 2, a circuit configuration is proposed in which the resistor R25 can be reduced without requiring a higher driving capability for the control unit 201.

The Example 2 differs from the Example 1 in the location where the PRI_CUR_CONT terminal is connected via the resistor R26. In the Example 2, technical matters different from those in the Example 1 are described in detail, and description of technical matters equivalent to those in the Example 1 is omitted.

### 1. Current Detection Circuit

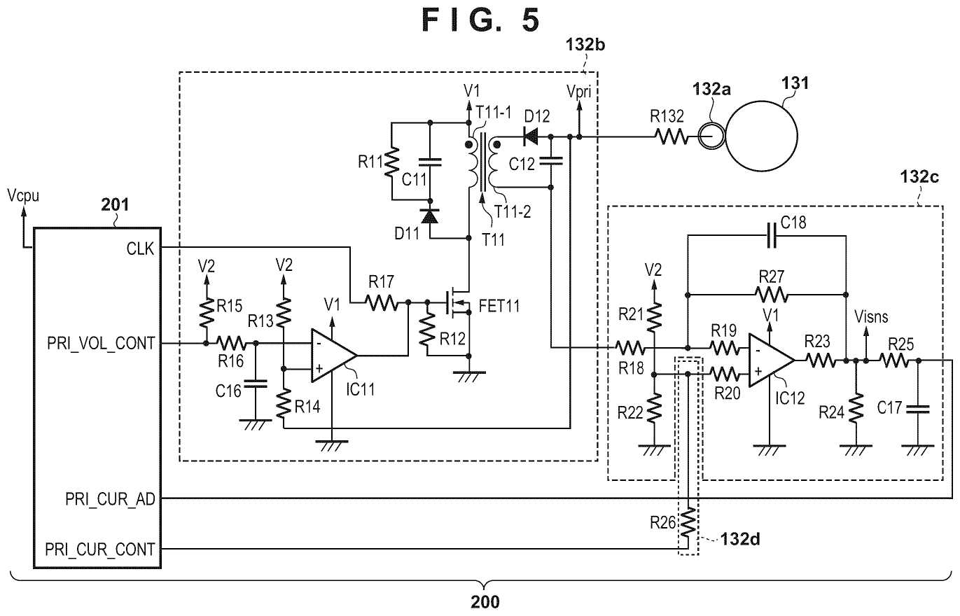

FIG. 5 shows a power supply apparatus 200 according to the Example 2. Comparing FIG. 5 with FIG. 2, in the current detection circuit 132c, a location where the PRI_CUR_CONT terminal is connected via the resistor R26 is different. That is, the PRI_CUR_CONT terminal is connected to a connection point between the resistor R20, the resistor R21, and the resistor R22 via the resistor R26.

When the control unit 201 controls the PRI_CUR_CONT terminal to be Hi-Z, the operating reference voltage Vref of the operational amplifier IC12 becomes a voltage Vref1 generated by dividing the power supply voltage V2 by the resistor R21 and the resistor R22. On the other hand, when the control unit 201 controls the PRI_CUR_CONT terminal to be Lo, the operating reference voltage Vref of the operational amplifier IC12 becomes a voltage Vref2 generated by dividing the power supply voltage V2 by the resistor R21 and a parallel connecting resistor of the resistor R22 and the resistor R26.

In the Example 2, the operating reference voltage Vref of the operational amplifier IC12 when the PRI_CUR_CONT terminal is controlled to be Hi-Z is designed to be suitable for current detection. The control unit 201 detects the output voltage (voltage V_AD) of the current detection circuit 132c at the PRI_CUR_AD terminal during a period of time in which the PRI_CUR_CONT terminal is controlled to be Hi-Z.

On the other hand, when the control unit 201 turns the PRI_CUR_CONT terminal to Lo, the operating reference voltage Vref of the operational amplifier IC12 decreases to the voltage Vref2, and accordingly, the Visns also decreases. Therefore, the voltage V_AD applied to the PRI_CUR_AD terminal decreases. In the Example 2, the Visns and the voltage V_AD are equal to each other. This is because the resistor R26 is not connected to the signal line of the PRI_CUR_AD terminal.

### 2. Control Flow

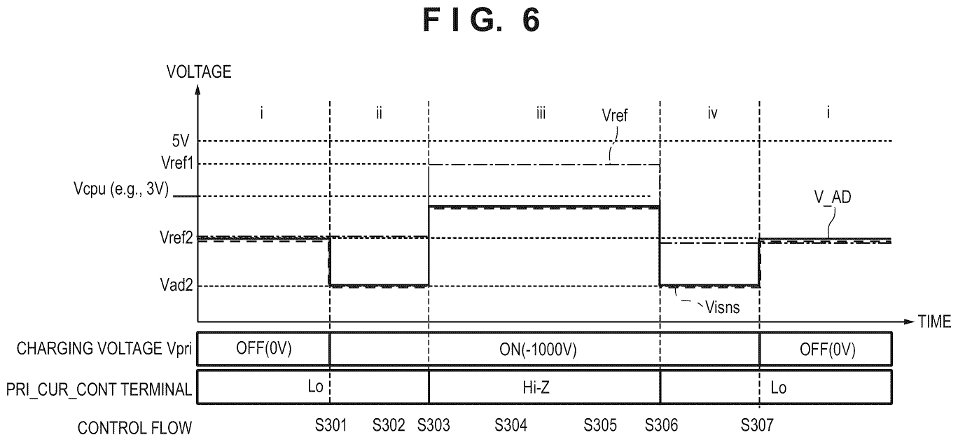

The control flow of the Example 2 is the same as that of the Example 1. However, since the voltage to be controlled is different from that of the Example 1, the different portions will be described with reference to FIG. 6.

FIG. 6 shows transition of each voltage in Example 2. The solid line indicates the voltage V_AD. The dashed lines indicate the Visns. The dashed-dotted line indicates the operating reference voltage Vref.

In the Example 2, the Visns and the voltage V_AD of the PRI_CUR_AD terminal are the same at all times. As shown in FIG. 6, the operational reference voltage Vref of the operational amplifier IC12 is variable and is the Vref1 or the Vref2 (Vref1>Vref2). That is, when the PRI_CUR_CONT terminal is Lo, the operating reference voltage Vref is equal to the Vref2. When the PRI_CUR_CONT terminal is Hi-Z, the operating reference voltage Vref is equal to the Vref1.

In phase i, the PRI_CUR_CONT terminal is controlled to Lo. Therefore, the operating reference voltage Vref of the operational amplifier IC12 is the Vref2. In phase i, the Visns and the voltage V_AD are also the Vref2.

In the phase ii, the PRI_CUR_CONT terminal is controlled to be Lo. Therefore, the operating reference voltage Vref of the operational amplifier IC12 is the Vref2. The Visns and the voltage Vad are controlled from the operating reference voltage Vref (=Vref2) of the operational amplifier IC12 to a voltage Vad2 lowered in accordance with the charging current Ipri.

In the phase iii, the PRI_CUR_CONT terminal is controlled to be Hi-Z. Therefore, the operating reference voltage Vref of the operational amplifier IC12 is controlled to the voltage Vref1.

In the phase iv, the PRI_CUR_CONT terminal is controlled to be Lo. Therefore, the operating reference voltage Vref of the operational amplifier IC12 is the Vref2.

According to the Example 2, the voltage V_AD is constantly suppressed to be equal to or lower than 3V. Therefore, the same effects as those of the Example 1 can be obtained in the Example 2. Further, in the Example 2, the resistance of the resistor R25 can be reduced without increasing the driving capability of the control unit 201.

### Example 3

### 1. Basic Concept

In the Examples 1 and 2, the control unit 201 determines whether or not to protect PRI_CUR_AD terminal based on whether or not the charging current Ipri is equal to or greater than the threshold value Ith. However, the control unit 201 may determine whether to protect PRI_CUR_AD terminal based on other information. That is, the information required for the determination may be any information that can distinguish between a state in which the PRI_CUR_AD terminal needs to be protected (non-detection state) and a detection state of the PRI_CUR_AD terminal. Therefore, in the Example 3, an example in which the charging voltage Vpri is used as the information required for the determination will be described. Note that redundant description of the matters described in the Examples 1 and 2 is omitted in the Example 3. That is, the description of the Examples 1 and 2 is incorporated in the Example 3.

### 2. Circuit Diagram

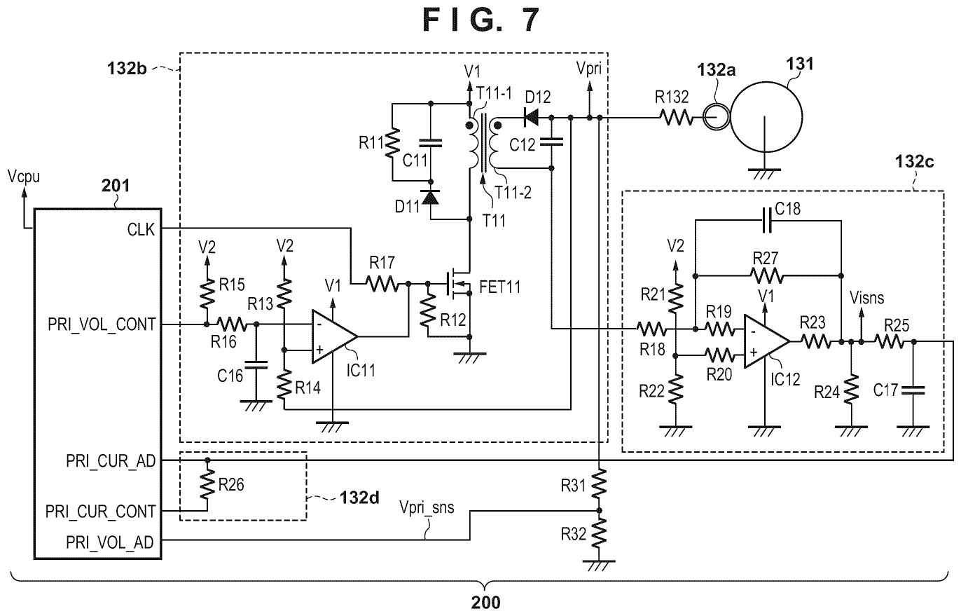

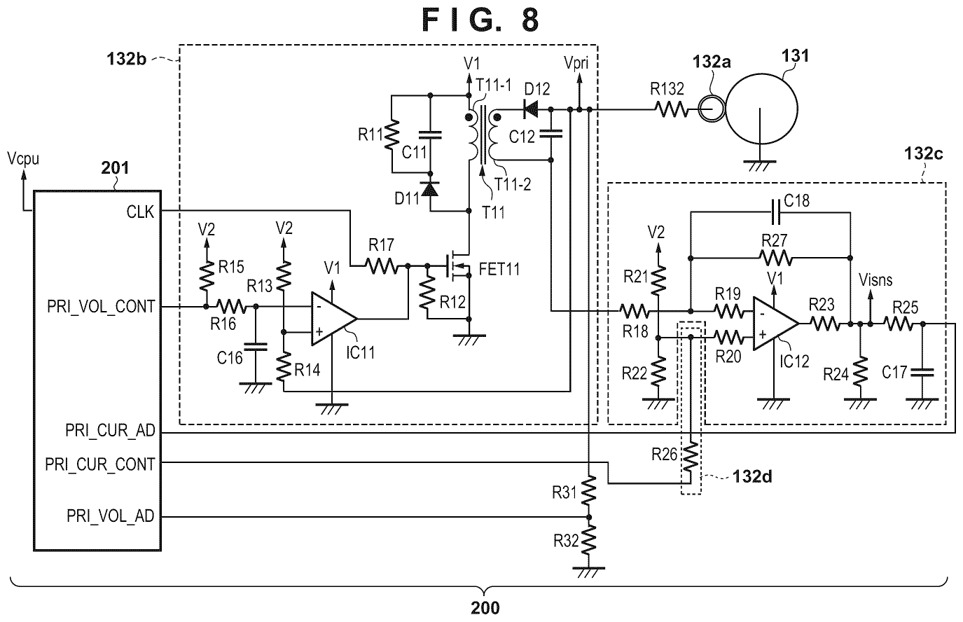

FIG. 7 shows a modification of the power supply apparatus 200 of the Example 1. FIG. 8 shows a modification of the power supply apparatus 200 of the Example 2. According to FIGS. 7 and 8, the charging voltage Vpri is converted into a detection voltage Vpri_sns by a voltage divider formed of a resistor R31 and a resistor R32 such that it can be inputted to the control unit 201. The control unit 201 has the PRI_VOL_AD terminal that is an input terminal with an AD converter. The PRI_VOL_AD terminal is connected to a connection point between the resistor R31 and the resistor R32, and receives the detection voltage Vpri_sns. Therefore, the control unit 201 determines whether or not to protect the PRI_CUR_AD terminal based on a voltage value (digital value) obtained by analog-to-digital converting the detection voltage Vpri_sns.

### 3. Flowchart

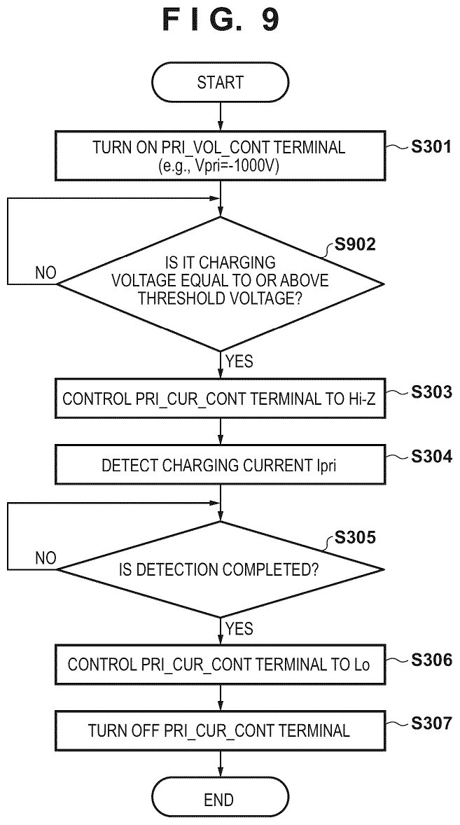

FIG. 9 is a flowchart illustrating an Example 3. In FIG. 9, compared to FIG. 3, S302 is replaced with S902. In S902, the control unit 201 determines whether or not the charging voltage Vpri is equal to or greater than the threshold voltage Vth. For example, the control unit 201 compares the detection voltage Vpri_sns proportional to the charging voltage Vpri with the threshold value Vth_sns proportional to the threshold voltage Vth. When the detection voltage Vpri_sns is equal to or higher than the threshold value Vth_sns, the charging voltage Vpri is equal to or higher than the threshold voltage Vth. When the detection voltage Vpri_sns is equal to or higher than the threshold value Vth_sns, the control unit 201 proceeds from S902 to S303. Therefore, the PRI_VOL_AD terminal is changed from the protection state to the detection state. In the Example 3, the initial state is also the protection state.

If the detection voltage Vpri_sns is not equal to or greater than the threshold value Vth_sns, the control unit 201 remains in S902 and maintains the PRI_VOL_AD terminal in the protection state. When the detection of the charging current Ipri is completed, the PRI_VOL_AD terminal is returned from the detection state to the protection state.

Thus, the Example 3 can exhibit the same effects as those of the Example 1 or the Example 2.

### Example 4

### 1. Basic Concept

In the Example 3, modifications of the Examples 1 and 2 have been described. The Example 4 is another modifications of the Examples 1 and 2. In the Example 4, an internal state of the control unit 201 is used as the information necessary for the determination of the switching from the protection state to the detection state. That is, the control unit 201 knows whether or not it is the timing at which the charging current Ipri should be detected based on the internal state of the control unit 201. For example, a predetermined time is required from a timing when output of the charging voltage Vpri is started to a timing when the charging voltage Vpri is stabilized. In other words, the control unit 201 starts the detection of the charging current Ipri by switching the PRI_VOL_AD terminal from the protection state to the detection state in consideration of the timing at which the charging voltage Vpri is stabilized. The predetermined time is generally constant. Therefore, the control unit 201 can specify the timing at which the charging voltage Vpri is stabilized (the detection timing of the charging current Ipri) by measuring the predetermined time using an internal timer or the like. Note that redundant description of the matters described in the Examples 1 and 2 is omitted in the Example 4. That is, the description of the Examples 1 and 2 is incorporated in the Example 4.

### 2. Circuit Diagram

The circuit diagram of Example 4 is as shown in FIG. 2.

### 3. Flowchart

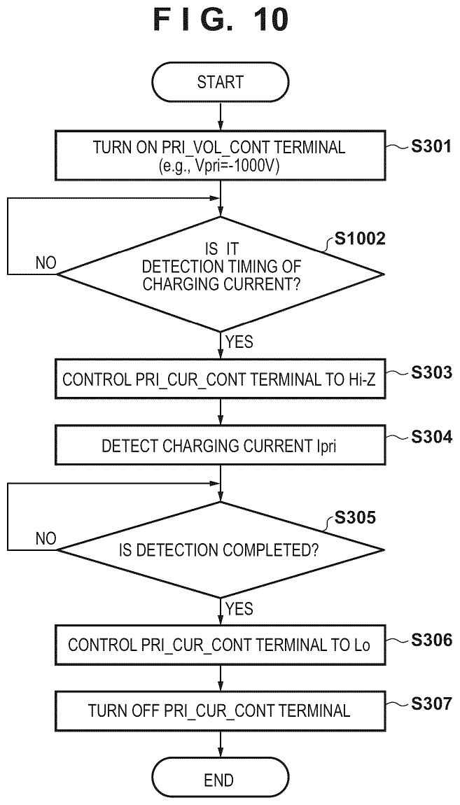

FIG. 10 is a flowchart illustrating Example 4. Compared with FIG. 3, S302 is replaced with S1002 in FIG. 10. In S1002, the control unit 201 determines whether or not the detection timing of the charging current Ipri has come based on the internal state managed by the control unit 201 (e.g., the elapsed time from the timing at which output of the charging voltage Vpri is started). For example, when the elapsed time from the timing at which output of the charging voltage Vpri is started becomes equal to or longer than the predetermined time, the control unit 201 determines that the detection timing of the charging current Ipri has come, and proceeds from S1002 to S303. Accordingly, the PRI_VOL_AD terminal is changed from the protection state to the detection state. If the detection timing of the charging current Ipri has not come, the control unit 201 remains in S1002 and maintains the PRI_VOL_AD terminal in the protection state.

Thus, the Example 4 can exhibit the same effects as those of the Examples 1 to 3.

### Other Examples

In the above-described examples, the PRI_VOL_AD terminal is protected from overvoltage based on the detection value of the charging current Ipri or the detection value of the charging voltage Vpri. However, this is only an example. For example, the duty ratio of the pulse signal outputted from the PRI_VOL_CONT terminal is a duty ratio corresponding to the target voltage of the charging voltage Vpri. For example, if the charging voltage Vpri is less than 600V, the PRI_VOL_AD terminal needs to be protected. Therefore, the duty ratio corresponding to −600V may be set as the threshold value. In this case, the control unit 201 sets the PRI_VOL_AD terminal to the protection state when the duty ratio determined based on the detection value of the charging current Ipri is less than the threshold value corresponding to −600V. The control unit 201 sets the PRI_VOL_AD terminal to the detection state when the duty ratio determined based on the detection value of the charging current Ipri is equal to or larger than the threshold value corresponding to −600V. In this manner, the protection state and the detection state may be switched based on the control value (duty ratio) of the charging voltage Vpri.

In the above-described examples, the control unit 201 executes the determination process for switching between the protection state and the detection state, but the determination process may be executed by a comparison circuit (for example, a comparator or the like) built in the control unit 201 or provided outside the control unit 201.

### Technical Ideas Derived from Examples

As shown in FIG. 2, the charging circuit 132b is an example of a power supply circuit. The charging roller 132a and the photosensitive drum 131 are examples of loads. The PRI_CUR_AD terminal is an example of an AD converter. The control unit 201 is an example of a determination circuit. The determination circuitry may be implemented by a comparator provided inside or outside the control unit 201, or may be implemented by a logical operation of a CPU provided inside the control unit 201. As described above, the control unit 201 controls the protection circuit 132d to lower the voltage applied to the input terminal (PRI_CUR_AD terminal) of an AD converter. As a result, the overvoltage to the control unit 201 is reduced when the output voltage (e.g., high voltage) is not output. It has been described that an overvoltage is applied to the input terminal of the AD converter; however the overvoltage does not actually need to be applied to the input terminal. That is, the determination circuit determines whether or not there is a possibility that the overvoltage is applied to the input terminal.

The resistor R25 and the resistor R26 are examples of voltage divider and voltage dividing circuit.

By using the voltage divider as described above, the control unit 201 may reduce the voltage applied to the input terminal (PRI_CUR_AD terminal) of the AD converter. That is, the control unit 201 can be protected from an overvoltage by a simple circuit configuration.

The operational amplifier IC12 and the resistor R27 are exemplary converter and conversion circuit that convert a current into a voltage. The resistor R25 is an example of the first resistor. The resistor R26 is an example of the second resistor. The PRI_VOL_CONT terminal is an example of the output terminal connected to the other end of the second resistor. The control unit 201 may control whether or not the voltage divider should divide the voltage Visns by using a signal (e.g., Lo/Hi-Z) outputted from the PRI_VOL_CONT terminal.

The resistor R27 is an example of a third resistor. The resistor R27 affects a resolution of a current detected by a current detection circuit. The power supply voltage V2 is an example of a voltage source and is an example of a reference voltage. Alternatively, the operating reference voltage Vref generated by the resistor R21 and the resistor R22 from the power supply voltage V2 is an example of the reference voltage. Each of the resistors R18 and R19 is an example of a fourth resistor.

As illustrated in FIG. 4 and the like, during a period of time in which no current is detected in the phases i, ii, iv, and the like, the reference voltage may be divided and the divided reference voltage may be applied to the input voltage.

In the Examples 1 to 4, the protection circuit 132d may control the voltage V_AD applied to the PRI_CUR_AD terminal to be equal to or lower than the operating voltage Vcpu (e.g., 3V) of the control unit 201.

Thus, the control unit 201 may be protected from the overvoltage.

As shown in FIGS. 4 and 6, the phase iii is an example of the detection period of time. The phases i, ii, and iv are examples of non-detection period of time.

The voltage V_AD proportional to the charging current Ipri is an example of the detection voltage. The threshold value Ith is a threshold value corresponding to the charging current Ipri, but the threshold value compared with the voltage V_AD in the control unit 201 is an exemplary threshold value compared with the detection voltage. According to S302, the PRI_CUR_AD terminal is switched from the protection state to the detection state when the detection voltage is equal to or higher than the threshold value. That is, when the detection voltage is less than the threshold value, the PRI_CUR_AD terminal is switched from the detection state to the protection state.

As described in the Example 3, the control unit 201 may determine whether an overvoltage is applied to the PRI_CUR_AD terminal based on the charging voltage Vpri having a high voltage.

As described in Examples 2 and 3, each of the resistors R21 and R22 is an example of the first resistor. The resistor R26 is an example of a second resistor that divides an operating voltage (e.g., V2) in cooperation with the resistor R21. The control unit 201 may decrease the voltage V_AD by switching whether to enable or disable the resistor R26 in the voltage divider.

As illustrated in FIGS. 5 and 8, the control unit 201 may control whether or not the voltage from the voltage source (e.g., the power supply voltage V2) is divided by a signal (Lo/Hi-Z) outputted from the PRI_VOL_CONT terminal connected to the resistor R26.

As shown in FIGS. 5 and 8, the resistor R22 is an example of the third resistor. As described above, in the phase iii, a high-impedance (Hi-Z) signal is outputted. In the phases i, ii, and iv, a Lo (low level signal) is outputted.

As shown in FIGS. 5 and 8, the resistor R27 is an example of the fourth resistor. The first reference voltage is a voltage generated by dividing the power supply voltage V2 by the resistor R21 and the resistor R22. The second reference voltage is a voltage generated by dividing a voltage by the resistor R21, the resistor R22, and the resistor R26.

As described in the Example 2, the second reference voltage is set to be lower than the Vcpu.

As shown in FIG. 6, the phase iii is an example of a detection period of time. The phase i, ii, and iv are exemplary non-detection periods of time.

As described in the Example 2, the voltage V_AD proportional to the charging current Ipri is an example of the detection voltage. The threshold value Ith is a threshold value corresponding to the charging current Ipri, but the threshold value compared with the voltage V_AD in the control unit 201 is an exemplary threshold value compared with the detection voltage. According to S302, the PRI_CUR_AD terminal is switched from the protection state to the detection state when the detection voltage is equal to or higher than the threshold value.

That is, when the detection voltage is less than the threshold value, the PRI_CUR_AD terminal is switched from the detection state to the protection state.

As indicated by S902, when the charging voltage Vpri is greater than or equal to the threshold value, the PRI_CUR_AD terminal is switched from the protection state to the detection state. That is, when the charging voltage Vpri is less than the threshold value, the PRI_CUR_AD terminal is switched from the detection state to the protection state. Note that the voltage Vpri_sns proportional to the charging voltage Vpri is an exemplary detection voltage.

As described in the Example 1 and the like, the charging voltage Vpri may be a negative-polarity high voltage (e.g., −1000V). The high voltage generally refers to an AC voltage equal to or higher than 600V, but may include an AC voltage lower than 600V.

The charging roller 132a is an example of the charging member. The developing roller 133a is an example of the developing member.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-205436, filed Dec. 5, 2023 which is hereby incorporated by reference herein in its entirety.

What is claimed is:

1. A power supplying apparatus comprising:
a power supply circuit configured to generate an output voltage;
a current detection circuit configured to detect a current flowing through a load to which the output voltage is applied; and
a controller configured to control the power supply circuit based on an output signal output from the current detection circuit,
wherein the controller comprises:
an AD converter configured to read the output signal;
a determination circuit configured to determine whether an overvoltage may be applied to an input terminal of the AD converter; and
a protection circuit configured to protect the input terminal of the AD converter from the overvoltage,
in a case where the determination circuit determines that the overvoltage may be applied to the input terminal of the AD converter, the controller controls the protection circuit to reduce a voltage applied to the input terminal of the AD converter.

2. The power supplying apparatus according to claim 1, wherein
the protection circuit includes a voltage dividing circuit configured to divide the voltage applied to the input terminal, and
the controller is configured to control whether or not to divide the voltage applied to the input terminal by the voltage dividing circuit.

3. The power supplying apparatus according to claim 2, wherein
the current detection circuit includes:
a conversion circuit configured to convert the current flowing through the load into a detection voltage proportional to the current; and
a first resistor connected between the conversion circuit and the input terminal to form a part of the voltage dividing circuit,
the voltage dividing circuit includes a second resistor one end of which is connected to a connection portion between the first resistor and the input terminal, and
the controller includes an output terminal connected to another end of the second resistor, and controls whether or not the voltage dividing circuit divides the voltage applied to the input terminal by a signal output from the output terminal.

4. The power supplying apparatus according to claim 3, wherein
the conversion circuit includes:
an operational amplifier having an inverting input terminal, a non-inverting input terminal, and an output terminal; and
a third resistor connected between the inverting input terminal and the output terminal, and affects a resolution of the current detected by the current detection circuit,
the non-inverting input terminal is supplied with a reference voltage from a voltage source, and
the current flows to the inverting input terminal via a fourth resistor.

5. The power supplying apparatus according to claim 4, wherein
in a period of time in which the controller does not detect the current using the current detection circuit, a voltage generated by dividing the reference voltage by the voltage dividing circuit is applied to the input terminal.

6. The power supplying apparatus according to claim 1, wherein
the protection circuit is configured to reduce the voltage applied to the input terminal to be less than or equal to an operating voltage of the controller.

7. The power supplying apparatus according to claim 1, wherein
the controller is configured to manage a detection period of time for detecting the current flowing through the input terminal of the AD converter and a non-detection period of time for not detecting the current flowing through the input terminal of the AD converter, and to perform protection of the input terminal by the protection circuit during the non-detection period of time.

8. The power supplying apparatus according to claim 3, wherein
the controller is configured to perform protection of the input terminal by the protection circuit in a case where the detection voltage, which is detected by the AD converter, proportional to the current falls below a threshold value.

9. The power supplying apparatus according to claim 1, wherein
the determination circuit is configured to determine whether the overvoltage is applied to the input terminal of the AD converter based on a value of the output voltage output from the power supply circuit.

10. The power supplying apparatus according to claim 1, wherein
the current detection circuit includes:
a conversion circuit configured to convert the current flowing through the load into a detection voltage proportional to the current; and
a first resistor connected between the conversion circuit and a voltage source,
the protection circuit includes a second resistor configured to form a voltage dividing circuit for dividing an operating voltage of the conversion circuit in cooperation with the first resistor, and
the controller is configured to reduce the detection voltage output from the conversion circuit to the input terminal by dividing the operating voltage of the conversion circuit by the voltage dividing circuit.

11. The power supplying apparatus according to claim 10, wherein
one end of the first resistor is connected to the voltage source,
another end of the first resistor is connected to one end of the second resistor, and
the controller includes an output terminal connected to another end of the second resistor, and is configured to control whether or not the voltage dividing circuit divides a voltage from the voltage source by a signal output from the output terminal.

12. The power supplying apparatus according to claim 11, further comprising
a third resistor including one end connected to the other end of the first resistor and another end connected to a ground,
wherein the one end of the second resistor is connected to the other end of the first resistor and the one end of the third resistor, and
the controller is configured to apply a signal related to a high impedance to the other end of the second resistor in a detection period of time in which the current is detected using the input terminal, and to apply a signal having a low level to the other end of the second resistor in a non-detection period of time in which the current is not detected using the input terminal.

13. The power supplying apparatus according to claim 12, wherein
the conversion circuit includes:
an operational amplifier including an inverting input terminal, a non-inverting input terminal, and an output terminal; and
a fourth resistor connected between the inverting input terminal and the output terminal and affecting a resolution of the current detection by the current detection circuit,
in a detection period of time in which the current detection circuit detects the current, the non-inverting input terminal is supplied with a first reference voltage generated by dividing a power supply voltage from the voltage source by the first resistor and the third resistor,
in a non-detection period of time in which the current detection circuit does not detect the current, the non-inverting input terminal is supplied with a second reference voltage generated by dividing the power supply voltage supplied from the voltage source by the first resistor, the second resistor, and the third resistor,
the second reference voltage is lower than the first reference voltage, and
the current flows to the inverting input terminal through a fifth resistor.

14. The power supplying apparatus according to claim 13, wherein
the second reference voltage is lower than an operating voltage supplied to the controller.

15. The power supplying apparatus according to claim 11, wherein
the controller is configured to manage a detection period of time for detecting the current flowing through the input terminal of the AD converter and a non-detection period of time for not detecting the current through the input terminal of the AD converter, and to perform protection of the input terminal by the protection circuit during the non-detection period of time.

16. The power supplying apparatus according to claim 11, wherein
the controller is configured to perform protection of the input terminal by the protection circuit in a case where the detection voltage, which is detected by the AD converter, proportional to the current falls below a threshold value.

17. The power supplying apparatus according to claim 11, wherein
the determination circuit is configured to determine whether the overvoltage is applied to the input terminal of the AD converter based on the output voltage output from the power supply circuit.

18. The power supplying apparatus according to claim 1, wherein
the power supply circuit is configured to apply a high voltage of negative polarity to the load, and
the current detection circuit is configured to detect the current flowing through the load in a case where the high voltage of negative polarity is applied to the load from the power supply circuit.

19. An image forming apparatus comprising:
a photosensitive member;
a charging member configured to charge the photosensitive member;
a developing member configured to develop an electrostatic latent image formed on the photosensitive member; and
a power supply apparatus configured to supply a charging voltage to the charging member,
wherein the power supply apparatus includes:
a power supply circuit configured to generate an output voltage;
a current detection circuit which detects a current flowing through a load to which the output voltage is applied; and
a controller configured to control the power supply circuit based on an output signal output from the current detection circuit,
wherein the controller comprises:
an AD converter configured to read the output signal;
a determination circuit configured to determine whether an overvoltage may be applied to an input terminal of the AD converter; and
a protection circuit configured to protect the input terminal of the AD converter from the overvoltage,
in a case where the determination circuit determines that the overvoltage may be applied to the input terminal of the AD converter, the controller controls the protection circuit to reduce the voltage applied to the input terminal of the AD converter.
